(19) United States
(12) Patent Application Publication
(10) Pub. No.: US 2006/0261811 A1
(43) Pub. Date: Nov. 23, 2006

(54) Magnetic resonance imaging system with a plurality of transmit coils

(76) Inventors: Cornelis Leonardus Gerardus Ham, Eindhoven (NL); Miha Fuderer, Eindhoven (NL)

Correspondence Address: PHILIPS INTELLECTUAL PROPERTY & STANDARDS, 595 MINER ROAD, CLEVELAND, OH, 44143, US

(21) Appl. No.: 10/537,451

(22) PCT Filed: Nov. 4, 2003
(86) PCT No.: PCT/IB03/05012

§ 371 Date: Jan. 3, 2005

(30) Foreign Application Priority Data
Dec. 6, 2002 (EP) 02080152.8

(51) Int. Cl. G01V 3/00

(52) U.S. Cl. 324/318; 324/320; 324/322

(57) ABSTRACT

The invention relates to an MRI system (1) for nuclear magnetic resonance imaging which comprises a plurality of transmit coils (11, 12). Each coil receives a coil drive signal (SD1, SD2). The respective coil drive signals have the same shape, but may have a different amplitude and phase, controlled by a controller (103) on the basis of characteristic information in a memory (104) as well as user input information. The controller is designed to set the respective amplitudes and phases in such a way that the resultant overall B1 field is as homogeneous as possible in a volume of interest.

The invention relates to a magnetic resonance imaging (MRI) system comprising:

an object space for receiving an object to be examined;

a main magnet system for generating a main magnetic field in the object space;

a gradient magnet system for generating gradients of the main magnetic field in the object space;

a plurality of transmit coils located adjacent the object space;

a coil drive circuit for generating a plurality of individual coil drive signals.

In the magnetic resonance imaging (MRI) technique, proton spins of a body under examination, for example a human body, are excited; after excitation, the spins return to their equilibrium state and in this process they transmit an electromagnetic field which is called a free induction decay signal (FID). This FID signal can be received and MR images derived therefrom. Since the MR imaging technique is well known per se and the present invention does not relate to the MR imaging technique as such, the MR imaging technique will not be explained in more detail, herein.

In the magnetic resonance imaging technique, a magnetic field is applied to the object under observation, the magnetic field having several components. The B0 field is a strong, static field which aligns the spins in a state of equilibrium. The B1 field is a high frequency field (normally a pulsed field) which excites the spins out of their state of equilibrium. The frequency of the B1 field depends on the application; it is usually in the radio frequency range (RF). Furthermore, gradient fields Gx, Gy and Gz are applied.

The B1 field may have components in X- and Y-directions, perpendicular to each other and to the B0 field direction. The B1X and B1Y fields may exhibit a certain predetermined phase relationship with respect to each other.

As is commonly recognized, it is desirable that the B1 field is homogeneous or uniform within a certain measuring volume. This means that the spins of the nuclei in a volume of interest are all excited to the same extent by the magnetic field.

MRI systems comprise transit means, including transmit antennas or coils, for generating the magnetic field to be applied to the body under examination, and receive means, including receive antennas or coils, for receiving the signals transmitted by the nuclei of such a body. The desirability of a homogeneous B1 field implies the desirability of a transmit antenna having a homogeneous transmit characteristic. Furthermore, for measuring integrity it is desirable that the receive antenna has a homogeneous sensitivity characteristic, meaning that the receive antenna is sensitive to the same extent to all nuclei within the volume of interest. If the receiver has an inhomogeneous sensitivity characteristic, it is usually possible to compensate for this aspect in subsequent image processing. However, if the transmit antenna has an inhomogeneous sensitivity characteristic, one consequence will be that different portions within the volume of interest will be excited in a different manner; the differences in excitation may then depend on the deviations from homogeneity in a non-linear way. This may lead to a loss of contrast in some portions of the volume of interest.

Therefore, a general objective of the present invention is to provide an MRI system of the kind mentioned in the opening paragraph with improved homogeneity of the B1 field.

A complicating factor in this respect is that the object in the volume of interest may have an effect on the B1 field. Due to its electrical properties, this is especially the case for human tissue. Even if the transmit antenna were to have an ideal homogeneous characteristic, the magnetic field within the object under observation might be inhomogeneous due to distortions caused by the object itself. Such distortions may be due to, for example, internal resonances within the object, or to absorption by the object.

A usual approach for compensating absorption is to increase transmit power. However, one obvious disadvantage is an increase in power dissipation in the object under investigation, which is especially undesirable in the case of examination of a human patient.

Therefore, the present invention aims to improve the homogeneity of the B1 field without substantially increasing overall transmit power, preferably even while reducing overall transmit power.

The desirability of a uniform B1 field has already been recognized in prior art. Previously proposed solutions include, for instance, the use of composite RF pulses or the use of adiabatic pulses. Both approaches involve a substantial increase in RF dissipation within the object under observation. Furthermore, composite RF pulses can only be used for a limited number of pulse types, for instance 90° pulses and 180° pulses; composite RF pulses do not solve the problem of providing, for instance, homogeneous 30° pulses.

U.S. Pat. No. 6,049,206 describes a complicated method which involves providing an initial, non-homogeneous B1 pulse and an additional pulse which consists of a phase modulation of the initial B1 pulse and has a time-dependent phase relationship with respect to the initial B1 pulse. Such an approach, besides being complicated, is only suitable for specific pulse types, specifically 90° pulses and 180° pulses.

An object of the present invention is to provide a magnetic resonance imaging system of the kind mentioned in the opening paragraph in which the homogeneity of the B1 field is improved with relatively simple means.

In order to achieve said object, a magnetic resonance imaging (MRI) system in accordance with the present invention is characterized in that the individual coil drive signals are generated by the coil drive circuit so as to have a substantially identical shape, the system having controllable means for individually setting the amplitude and/or phase of each of said coil drive signals, and a controller for controlling said controllable means. In an MRI system according to the invention the transmit means comprise at least two transmit antennas or coils. The individual antennas are driven by an RF pulse derived from one basic signal, but weighted by individual weighing factors, in such a way that the resultant overall B1 field is substantially homogeneous within the volume of interest.

These and other aspects, features and advantages of the present invention will be further explained by the following description of the present invention with reference to the drawings, in which corresponding reference numerals indicate corresponding or similar parts, and in which:

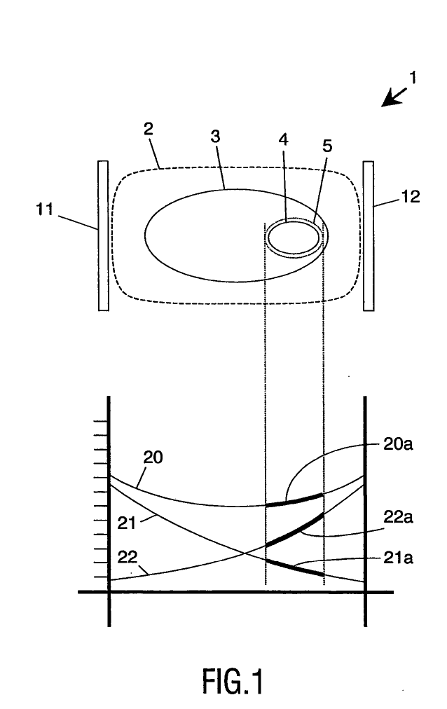

FIG. 1 schematically illustrates an arrangement of two coils and the resultant magnetic field in an object space;

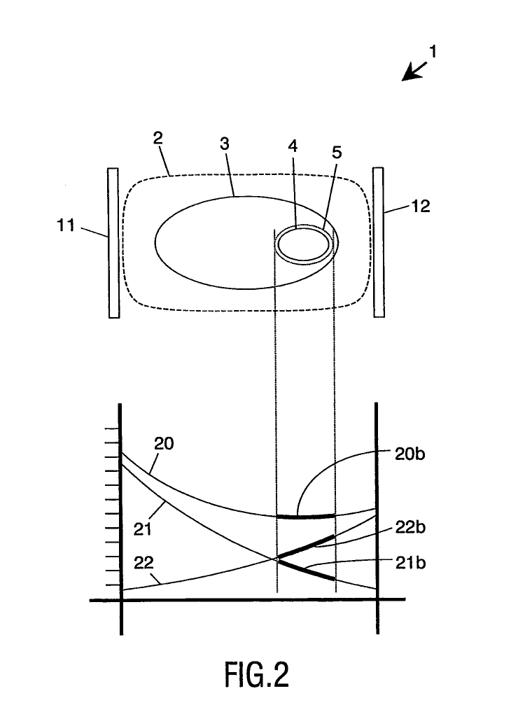

FIG. 2 is comparable to FIG. 1, illustrating the effect of the invention on the homogeneity of the magnetic field; and

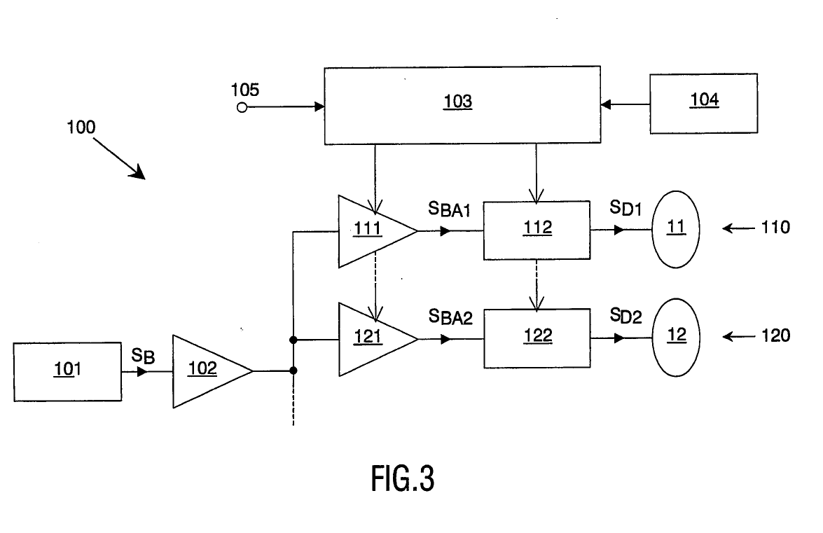

FIG. 3 is a block diagram schematically illustrating an embodiment of a coil drive circuit.

FIG. 1 schematically illustrates an MRI system 1 according to the invention which is used to form images of the intestines of for example, a human body by means of nuclear magnetic resonance (NMR) techniques. The MRI system 1 has an object space 2 for receiving an object 3 to be examined. The MRI system 1 also comprises a main magnet system for generating a main magnetic field in the object space 2, and a gradient magnet system for generating gradients of the main magnetic field in the object space 2. The main magnet system and the gradient magnet system are not shown in FIG. 1 because the exact structure and details of the main magnet system and the gradient magnet system are not relevant for the present invention. The main magnet system and the gradient magnet system may be of a kind known to and generally used by a person skilled in the art of magnetic resonance imaging systems. The MRI system 1 comprises first and second transmit antennas 11 and 12, hereinafter indicated briefly as “coils”, each designed for generating an RF magnetic field. The two coils 11 and 12 are located on opposite sides of the object space 2. An object located in the object space 2 is generally indicated by the reference 3; this object may for instance be a human body. An object part within the object 3 is generally indicated by the reference 4; this object part may for instance be a human liver. In the following explanation it is assumed that it is desired to obtain an image of the liver of a human being; thus, a volume of interest 5 is defined by object part 4. The volume of interest 5 may in principle be identical to the volume occupied by the liver, but in this case, for easy reference, the volume of interest 5 is taken to be slightly larger than the volume of the liver 4.

FIG. 1 also shows a graph containing curves 21 and 22 indicating the local field strength of the magnetic field generated by the first coil 11 and the second coil 12, respectively. The horizontal axis of this graph indicates location and is aligned with the schematic drawing of the MRI system 1.

It can clearly be seen from the curve 21 of this graph that the first coil 11 generates a non-homogeneous field having its highest intensity coinciding with the location of the first coil 11 and generally decreasing with distance. Especially the magnetic field generated by the first coil 11 is not homogeneous at the location of the volume of interest 5 (see part 21a of the curve 21).

Likewise, it can clearly be seen from the curve 22 of this graph that the second coil 12 generates a non-homogeneous field having its highest intensity coinciding with the location of the second coil 12 and generally decreasing with distance. Especially the magnetic field generated by the second coil 12 is not homogeneous at the location of the volume of interest 5 (see part 22a of the curve 22).

It is noted that, in this example, the curves 21 and 22 are identical; however, although such is preferred, it is not essential for the present invention.

The overall B1 field generated by the coils 11 and 12, i.e. a direct summation of the fields 21 and 22, is shown at 20 in the graph of FIG. 1. In the state of the art, both coils 11 and 12 generate the same field strength, i.e. they receive substantially the same amount of power, as illustrated by the curve 20. It can clearly be seen in this case that the B1 field 20 is not homogeneous at the location of the volume of interest 5 (see part 20a of the curve 20). The B1 field 20 has a minimum, around which the B1 field is substantially homogeneous, but this minimum has a fixed location within the object space 2, which location does not necessarily correspond to the location of the volume of interest 5.

FIG. 2 is comparable to FIG. 1, except that the graph illustrates a situation where the overall power applied to the coils is redistributed such that the first coil 11 receives more power and the second coil 12 receives less power as indicated by the first field curve 21 which is raised and the second field curve 22 which is lowered relative to their positions in FIG. 1. The redistribution of power can be done such that the overall amount of power remains the same. According to the principles of the present invention, the redistribution of power is done in such a way that the B1 field 20 is as homogeneous as possible at the location of the volume of interest 5 (see part 20b of the curve 20).

It is noted that in the example of the FIGS. 1 and 2 two coils 11 and 12 are used for illustrating the principles of the present invention. However, the present invention is not restricted to the use of two coils; in fact, the number of coils may be any number larger than one, although in practice the number will not be very large.

It is further noted that in the above example only the effect of relative amplification/attenuation of the two coil signals is discussed. In practice it may also be appropriate to introduce a relative phase shift between the two coil signals in order to compensate for relative delays caused by differences in propagation velocity of the field in the object under observation.

FIG. 3 schematically illustrates an embodiment of a coil drive circuit 100 for implementing the above coil drive method in the MRI system 1. A signal generator 101 generates a basic signal S_{B}. If required, an amplifier 102 amplifies this basic signal S_{B}; such an amplifier may also be incorporated in the signal generator 101. Since such a signal generator for generating a basic nuclear magnetic resonance (NMR) drive signal is commonly known and the present invention can be implemented using a prior art signal generator, it is not necessary here to discuss the design of such a generator in more detail. Moreover, since a suitable shape of a basic NMR drive signal is known to persons skilled in this art, it is not necessary either to discuss such a shape in more detail.

The coil drive circuit 100 comprises a plurality of coil drive branches 110, 120, etc for driving the plurality of coils 11, 12, etc. In this example only two coils 11 and 12 are discussed; therefore, only two corresponding branches 110, 120 are shown. Each coil drive branch 110, 120 comprises a series arrangement of a controllable amplifier/attenuator 111, 121 and a controllable phase shifter 112, 122, controlled by a controller 103 which has an associated memory 104. In the example shown, the phase shifter is always arranged behind the amplifier, but this order may also be reversed.

Each branch 110, 120 has its input side (in this case the input of amplifier/attenuator 111, 121) coupled to the output of the generator amplifier 102. Each amplifier/attenuator 111, 121 amplifies or attenuates its input signal with a gain factor G1, G2 under the control of the controller 103 so as to provide an amplified signal S_{BA1}, =G1·S_{B} and S_{BA2}=G2·S_{B}, respectively. Each phase shifter 112, 122 generates an output signal S_{D1} and S_{D2}, respectively, which is substantially identical to its input signal S_{BA1} and S_{BA2}, respectively, but delayed by a delay δ1, δ2 under the control of the controller 103. The output signals S_{D1} and S_{D2}, respectively, are applied to the coils 11 and 12, respectively. Thus, the coils 11, 12 are driven by coil drive signals S_{D1}, S_{D2}, respectively, which can be written as:
S_{D1}(t+δ1)=G1·S_{B}(t)
S_{D2}(t+δ2)=G2·S_{B}(t)
wherein t represents time.

The controller 103 is designed to control the gain G1 and G2 applied by amplifier/attenuator 111 and 121, respectively, and the phase shifts δ1 and δ2 applied by the phase shifter 112 and 122, respectively, in such a way that the coils 11, 12 receiving said output signals S_{D1}(t+δ1)=G1·S_{B}(t) and S_{D2}(t+δ2)=G2·S_{B}(t), respectively, generate magnetic field contributions 21, 22 such that the resultant overall magnetic field 20 is as homogeneous as possible in the volume of interest 5 (see 22b in FIG. 2). In order to enable the controller 103 to do so, the memory 104 contains information on the field characteristics of each coil 11, 12 (curves 21, 22 in FIG. 1) as well as information on field distortions caused by the object 3 in the object space 2. The controller 103 also has a user input 105, allowing a user to input a selection of an object part 4 of the object 3. For instance, if the object 3 is a human body, the user can for instance select the liver or the stomach or any other organ as object part of interest Based on this input information, and on the information in the memory 104, the controller 103 sets the gains G1, G2 and the phase shifts 61, 82 such that the overall B1 field in the selected object part of interest is substantially homogeneous.

It is noted that the present invention does not necessarily aim to improve the homogeneity in the entire object space 2. Instead, the present invention aims to improve the homogeneity of the resultant overall B1 field in a volume of interest. To this end, the present invention provides an MRI system 1 which comprises a plurality of transmit coils 11, 12. Each coil receives a coil drive signal S_{D1}, S_{D2} from a coil drive branch 110, 120. According to an important aspect of the present invention, each coil drive branch 110, 120 receives the same input signal from a signal generator 101, so that all coils 11, 12 receive electrical signal pulses having the same shape, be it that the electrical signal pulses from different coils may have a different amplitude and a different phase, controlled by a controller 103 on the basis of characteristic information in a memory 104 as well as user input information. The controller is designed to set the respective amplitudes and phases in such a way that the resultant overall B1 field is as homogeneous as possible in the volume of interest.

It is further noted that the “degree of success” of the control action by the controller 103 depends on circumstances. Generally speaking, the smaller the size of the volume of interest 5, the better the homogeneity of the B1 field will be. At any rate, the present invention succeeds in providing a homogeneity better than if all coils were driven with the same amplitude and phase.

It should be clear to a person skilled in the art that the present invention is not limited to the exemplary embodiments discussed above, but that various variations and modifications are possible within the protective scope of the invention as defined in the appended claims. For instance, although the volume of interest in the FIGS. 1 and 2 is shown as a 2D surface, the present invention is not restricted to 2D volumes; instead, the volume of interest may be a 1D volume or a 3D volume.

1. A magnetic resonance imaging (MRI) system comprising:
an object space for receiving an object to be examined;
a main magnet system for generating a main magnetic field in the object space;
a gradient magnet system for generating gradients of the main magnetic field in the object space;
a plurality of transmit coils located adjacent the object space;
a coil drive circuit for generating a plurality of individual coil drive signals,
characterized in that the individual coil drive signals are generated by the coil drive circuit so as to have a substantially identical shape, the system having controllable means for individually setting the amplitude and/or phase of each of said coil drive signals, and a controller for controlling said controllable means.

2. An MRI system as claimed in claim 1, wherein said controller has a user input for receiving a user input signal defining or selecting a volume of interest within said object space.

3. An MRI system as claimed in claim 1, wherein said coil drive circuit comprises a signal generator for generating a basic signal and a plurality of coil drive branches for driving a respective one of the plurality of coils, said drive branches being coupled to receive input signals derived from or identical to said basic signal.

4. An MRI system as claimed in claim 3, wherein each coil drive branch has its input coupled to one output of said signal generator.

5. An MRI system as claimed in claim 3, wherein said coil drive circuit also comprises a basic amplifier having an input connected to an output of said signal generator, each coil drive branch having its input coupled to one output of said basic amplifier.

6. An MRI system as claimed in claim 3, wherein each coil drive branch comprises a controllable amplifier.

7. An MRI system as claimed in claim 3, wherein each coil drive branch comprises a controllable phase shifter.

8. An MRI system as claimed in claim 6, wherein said controller is coupled to control said controllable amplifier and/or said controllable phase shifter.

9. An MRI system as claimed in claim 8, wherein the system also comprises a memory, associated with said controller, for storing information on the field characteristics of each coil and for storing information on field distortions caused by an object in the object space.

10. An MRI system as claimed in claim 9, wherein said controller is designed to:
receive input information at an input, said input information relating to a type of object in the object space and a selection of an object party;
read from said memory individual field characteristics of the individual transmit coils as well as field distortion characteristics of the object in the object space;
control the settings of said controllable amplifier and/or the settings of said controllable phase shifter, taking into account said information received at said input as well as said information read from said memory, in such a way that, an overall magnetic field of improved homogeneity, is obtained in a predetermined volume of interest corresponding to said object part.

11. An MRI system as claimed in claim 10, wherein said controller is designed to control the settings of said controllable amplifier and/or the settings of said controllable phase shifter in such a way that an overall magnetic field has a locally substantially constant magnitude at a location within said volume of interest, preferably at the center of said volume of interest.
